(19) United States
(12) Patent Application Publication
(10) Pub. No.: US 2012/0254852 A1
(43) Pub. Date: Oct. 4, 2012

(54) METHOD AND APPARATUS TO DEPLOY FIRMWARE

(75) Inventor: Hironori EMARU, Santa Clara, CA (US)

(73) Assignee: HITACHI, LTD., Tokyo (JP)

(21) Appl. No.: 13/075,556

(22) Filed: Mar. 30, 2011

(51) Int. Cl. G06F 9/44; G06F 9/445

(52) U.S. Cl. 717/173; 717/178

(57) ABSTRACT

In an information system, a management server is configured to specify one or more storage areas in one or more storage systems for distributing a firmware, and to create an access control table which sets access control for permissible access to the firmware in the one or more storage areas. A plurality of servers are configured to download the firmware from the one or more storage areas by checking the access control table for permission to download the firmware, to apply the downloaded firmware if the firmware is downloaded, and to write, to the one or more storage areas from which the firmware has been downloaded, status information indicating result of applying the downloaded firmware. The management server is configured to acquire the status information from each of the one or more storage areas from which the firmware has been downloaded.

### BACKGROUND OF THE INVENTION

The present invention relates generally to storage systems and, more particularly to methods and apparatus to deploy firmware/patch.

There is a recent trend toward increasing consolidation in the datacenter. A lot of IT resources such as servers and storages are placed in one datacenter. Such IT resources have firmware that governs the operation of the resources. Usual firmware of IT resources has a function to update. In a similar way, the functions of operating system and application can be updated by the use of patches.

Traditionally, firmware/patch deployments have been achieved by inserting a computer readable medium such as a diskette or CD into an appropriate drive. Recently, a management server is placed in the datacenter. The management server gets the latest firmware from a vendor's website, and then deploys the firmware to each of its resources. The management server may be a cause of bottleneck, if one management server deploys firmware/patch to all of the IT resources in one datacenter. One solution is to place multiple management servers in the datacenter. In that case, someone has to manage the relationship between management server(s) and managed resources. Additionally, virtual machines may move among servers by live migration function in the virtual server environment. In this environment, the relationship between management server(s) and managed resources becomes broken because of migration. Current firmware/patch deployment system cannot solve the following two problems in parallel: (1) scalability and (2) coping with a change of system configuration dynamically.

U.S. Patent Publication No. 2006/0048144 A1 discloses a firmware distribution system for the IP telephony. A peer-to-peer network configuration is created by the multiple endpoints. One endpoint acts as a master device. A master device distributes a firmware to the remaining endpoints in the peer-to-peer network. U.S. Patent Publication No. 2010/0191867 A1 discloses a system for performing field updates of firmware. A source device and multiple target devices are directly connected. A source device sends firmware to each target device. The source device is operable to validate the completion of the firmware update in the target device. U.S. Pat. No. 7,197,634 B2 discloses system and method to provide firmware to remote devices. Firmware is downloaded to the storage of the remote device. If the firmware is stored successfully, a success flag is set. During the next boot of the device, downloaded firmware is applied base of the flag.

### BRIEF SUMMARY OF THE INVENTION

Exemplary embodiments of the invention provide methods and apparatus that are scalable and adaptable for dynamically changing environment firmware/patch deployment system. In specific embodiments, a firmware/patch is deployed and stored in multiple storage subsystems. Servers/Virtual Machines download the firmware/patch from near/local storage subsystems base on a Mapping Management Table. The servers/virtual machines write the result of application of the firmware/patch to the near/local storage subsystem. The management server retrieves the results from each of the storage subsystems. This technique can be used for efficient deployment of firmware of server or storage in the datacenter. It can also be used for efficient deployment of firmware patch of virtual machine or application in the datacenter.

In accordance with an aspect of the present invention, an information system comprises a plurality of storage systems; a plurality of servers; a management server; and a network coupled with the storage systems, the servers, and the management server. The management server is configured to specify one or more storage areas in one or more of the storage systems for distributing a firmware, and to create an access control table which sets access control for permissible access to the firmware in the one or more storage areas in one or more of the storage systems. The servers are configured to download the firmware from the one or more storage areas by checking the access control table for permission to download the firmware, to apply the downloaded firmware if the firmware is downloaded, and to write, to the one or more storage areas from which the firmware has been downloaded, status information indicating result of applying the downloaded firmware. The management server is configured to acquire the status information from each of the one or more storage areas from which the firmware has been downloaded.

In some embodiments, the one or more servers are configured, prior to writing status information indicating result of applying the downloaded firmware, to check the access control table which sets access control for permissible updating of the status information in each of the one or more storage areas from which the firmware has been downloaded to indicate success or failure of applying the downloaded firmware by the one or more servers. The management server is configured to check the status information in each of the one or more storage areas from which the firmware has been downloaded, and to delete the firmware in a specific storage area if the status information indicates success of applying the firmware downloaded from the specific storage area. The management server is configured to check the status information in each of the one or more storage areas from which the firmware has been downloaded, and to notify an error if the status information indicates failure of applying the firmware downloaded from a specific storage area.

In specific embodiments, the management server is configured to create a mapping management table which maps each server to any storage area in the storage systems from which the server may download a firmware, and the servers are configured to check whether any new firmware exists in the storage systems by using the mapping management table. The management server is configured to create a mapping management table which maps one or more target storage systems from among the plurality of storage systems to one or more storage areas in one or more source storage systems from among the plurality of storage systems, a target storage system being permitted to download a firmware from a storage area in a source storage system as mapped according to the mapping management table. The one or more target storage systems are configured to download the firmware from the one or more storage areas of the one or more source storage systems by checking the access control table for permission to download the firmware, and to apply the downloaded firmware if the firmware is downloaded, and to write, to the one or more storage areas from which the firmware has been downloaded, status information indicating result of applying the downloaded firmware.

In some embodiments, one or more of the servers each include one or more virtual machines. The firmware comprises a patch. The one or more virtual machines are configured to download the patch from the one or more storage areas by checking the access control table for permission to download the patch, to apply the downloaded patch if the patch is downloaded, and to write, to the one or more storage areas from which the patch has been downloaded, status information indicating result of applying the patch.

In specific embodiments, the servers and storage systems are divided into a plurality of converged platforms which are coupled via the network, each converged platform having a subset of the servers and a subset of the storage systems. For each converged platform, the management server specifies a storage area in one storage system in the subset of the storage systems for distributing a patch in the converged platform, and the access control table sets access control for permissible access to the patch in the storage area by the virtual machines of all the servers in the same converged platform.

In accordance with another aspect of the invention, an information system comprises a plurality of storage systems; a plurality of servers; a management server; and a network coupled with the storage systems, the servers, and the management server. The management server is configured to specify one or more storage areas in one or more of the storage systems for distributing a firmware, and to create an access control table which sets access control for permissible access to the firmware in the one or more storage areas in one or more of the storage systems. The management server is configured to create a mapping management table which maps one or more target storage systems from among the plurality of storage systems to one or more storage areas in one or more source storage systems from among the plurality of storage systems, a target storage system being permitted to download a firmware from a storage area in a source storage system as mapped according to the mapping management table. The one or more target storage systems are configured to download the firmware from the one or more storage areas of the one or more source storage systems by checking the access control table for permission to download the firmware, and to apply the downloaded firmware if the firmware is downloaded, and to write, to the one or more storage areas from which the firmware has been downloaded, status information indicating result of applying the downloaded firmware. The management server is configured to acquire the status information from each of the one or more storage areas from which the firmware has been downloaded.

In some embodiments, the one or more target storage systems are configured, prior to writing status information indicating result of applying the downloaded firmware, to check the access control table which sets access control for permissible updating of the status information in each of the one or more storage areas from which the firmware has been downloaded to indicate success or failure of applying the downloaded firmware by the one or more target storage systems.

In accordance with another aspect of this invention, an information system comprises a plurality of storage systems; a plurality of servers each including one or more virtual machines; a management server; and a network coupled with the storage systems, the servers, and the management server. The management server is configured to specify one or more storage areas in one or more of the storage systems for distributing a patch, and to create an access control table which sets access control for permissible access to the patch in the one or more storage areas in one or more of the storage systems. The one or more virtual machines are configured to download the patch from the one or more storage areas by checking the access control table for permission to download the patch, to apply the downloaded patch if the patch is downloaded, and to write, to the one or more storage areas from which the patch has been downloaded, status information indicating result of applying the patch. The management server is configured to acquire the status information from each of the one or more storage areas from which the patch has been downloaded.

In some embodiments, the one or more virtual machines are configured, prior to writing status information indicating result of applying the patch, to check the access control table which sets access control for permissible updating of the status information in each of the one or more storage areas from which the patch has been downloaded to indicate success or failure of applying the patch by the one or more virtual machines. The management server is configured to create a mapping management table which maps each virtual machine to any storage area in the storage systems from which the virtual machine may download a patch; and the virtual machines are configured to check whether any new patch exists in the storage systems by using the mapping management table.

In specific embodiments, the management server is configured to create a mapping management table which maps one or more target storage systems from among the plurality of storage systems to one or more storage areas in one or more source storage systems from among the plurality of storage systems, a target storage system being permitted to download a patch from a storage area in a source storage system as mapped according to the mapping management table. The one or more target storage systems are configured to download the patch from the one or more storage areas of the one or more source storage systems by checking the access control table for permission to download the patch, and to apply the downloaded patch if the patch is downloaded, and to write, to the one or more storage areas from which the patch has been downloaded, status information indicating result of applying the downloaded patch.

These and other features and advantages of the present invention will become apparent to those of ordinary skill in the art in view of the following detailed description of the specific embodiments.

### BRIEF DESCRIPTION OF THE DRAWINGS

FIG. 1 shows an example of a system configuration of a Datacenter system according to the first embodiment.

FIG. 2 shows an example of a configuration of Management Server in the Datacenter.

FIG. 3 shows an example of a configuration of Server in the Datacenter according to the first embodiment.

FIG. 4 shows an example of a configuration of Storage Subsystem in the Datacenter according to the first embodiment.

FIG. 5 shows an example of Mapping Management Table in the Management Server according to the first embodiment.

FIG. 6 shows an example of Status Management Table in the Management Server according to the first embodiment.

FIG. 7 shows an example of Mapping Management Table in the Server.

FIG. 8 shows an example of Status Management Table in the Storage Subsystem according to the first embodiment.

FIG. 9 shows an example of Access Control Table in the Storage Subsystem according to the first embodiment.

FIG. 10 shows an example of a flow diagram illustrating the process of Firmware Update Program of the server as applied to the Management Server.

FIG. 11 shows an example of a flow diagram illustrating the process of the Firmware Management Program to update the Mapping Management Table in the Management Server.

FIG. 12 shows an example of a flow diagram illustrating the process of the Firmware Update Program in the Server.

FIG. 13 shows an example of a configuration of the Storage Subsystem in the Datacenter according to the second embodiment.

FIG. 14 shows an example of Mapping Management Table in the Management Server according to the second embodiment.

FIG. 15 shows an example of Status Management Table in the Management Server according to the second embodiment.

FIG. 16 shows an example of Status Management Table in the Storage Subsystem according to the second embodiment.

FIG. 17 shows an example of Access Control Table in the Storage Subsystem according to the second embodiment.

FIG. 18 shows an example of a configuration of the Server according to the third embodiment.

FIG. 19 shows an example of a logical configuration of a Datacenter system that includes Servers and Storage Subsystems according to the third embodiment.

FIG. 20 shows an example of a system configuration of the Datacenter system according to the fourth embodiment.

FIG. 21 shows an example of a logical configuration of the system that includes the Converged Platforms according to the fourth embodiment.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for deploying firmware/patch.

### Embodiment 1

### Updating Firmware of Server

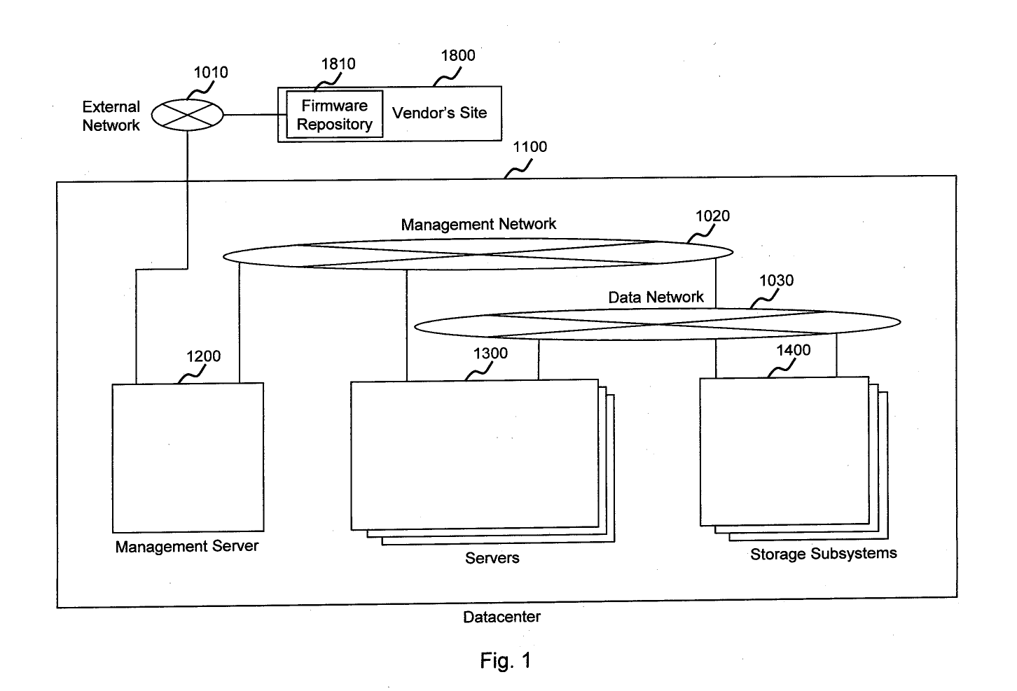

FIG. 1 shows an example of a system configuration of a datacenter according to the first embodiment. The Datacenter 1100 includes Management Server 1200, Servers 1300, and Storage Subsystems 1400. The Management Server, Servers, and Storage Subsystems are connected via Management Network 1020. The network is typically Ethernet LAN but is not limited to that. The Servers 1300 and Storage Subsystems 1400 are connected via Data Network 1030. The network is typically SAN (Storage Area Network) but it is not limited to that. In this embodiment, The Management Network 1020 and Data Network 1030 are separate. The Management Server 1200 is connected to Vendor's site 1800 via External Network 1010. The Vendor's site 1800 is a website or FTP site or the like. It contains Firmware Repository 1810, in which firmware is stored.

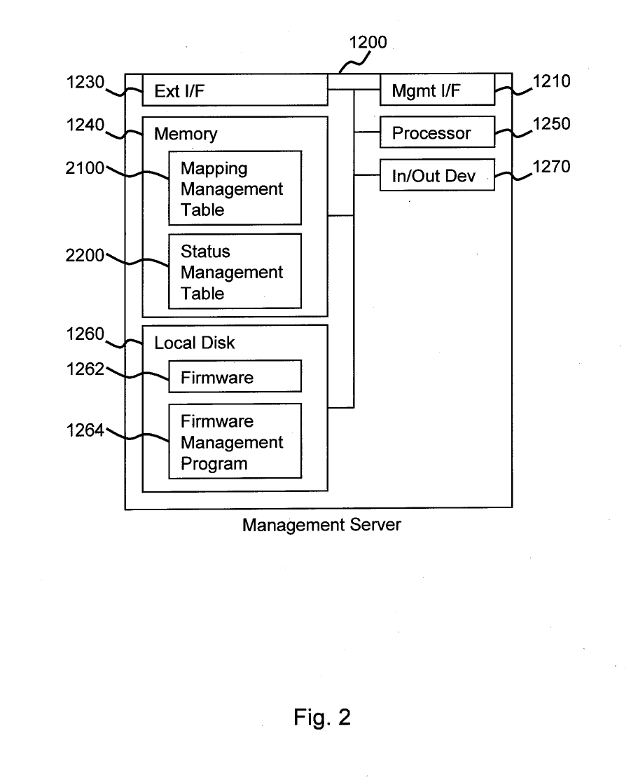

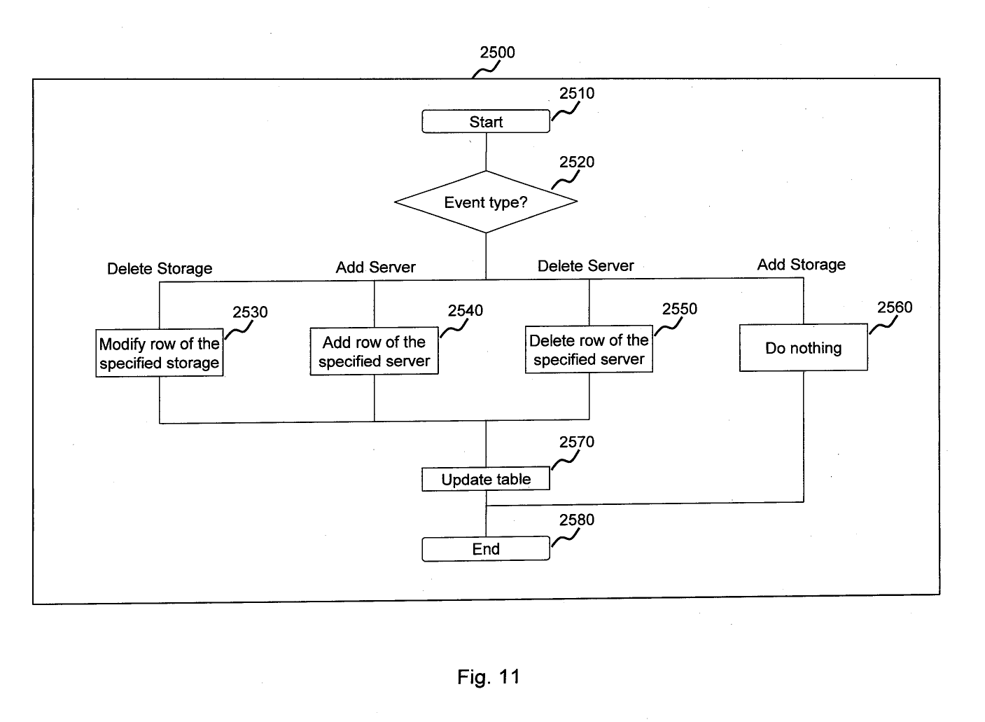

FIG. 2 shows an example of a configuration of the Management Server 1200 in the Datacenter 1100. Management Interface 1210 is an interface to the Management Network 1020. External Interface 1230 is an interface to the External Network 1010. Input/Output Device 1270 is a user interface such as monitor, keyboard, and mouse. Local Disk 1260 contains Firmware 1262 and Firmware Management Program 1264. The Firmware Management Program 1264 is loaded to Memory 1240 and executed by Processor 1250. The Memory 1240 stores Mapping Management Table 2100 and Status Management Table 2200. The process of the Firmware Management Program 1264 is discussed below (see FIG. 11).

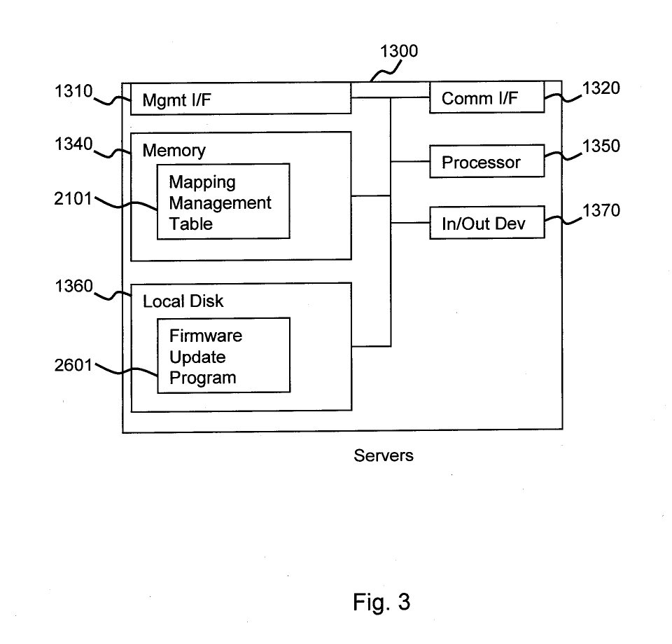

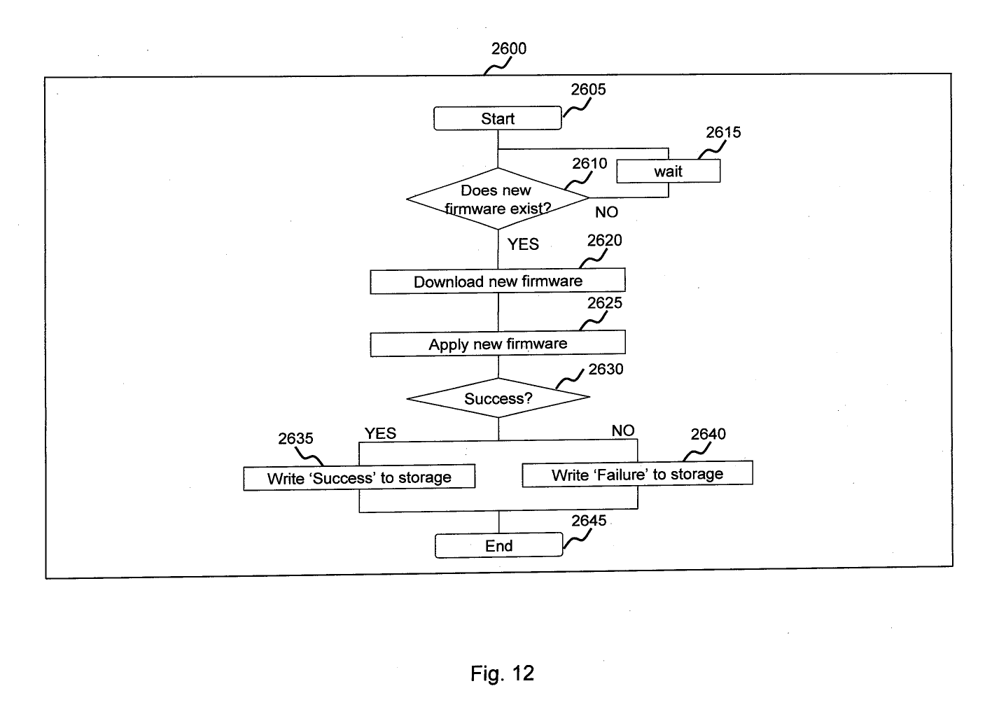

FIG. 3 shows an example of a configuration of the Server 1300 in the Datacenter 1100 according to the first embodiment. Management Interface 1310 is an interface to the Management Network 1020. Communication Interface 1320 is an interface to the Data Network 1030. Local Disk 1360 contains Firmware Update Program 2601. The Firmware Update Program 2601 is loaded to Memory 1340 and executed by Processor 1350. The Memory 1340 stores Mapping Management Table 2101. The procedure of the Firmware update Program 2601 is discussed below (see FIG. 12).

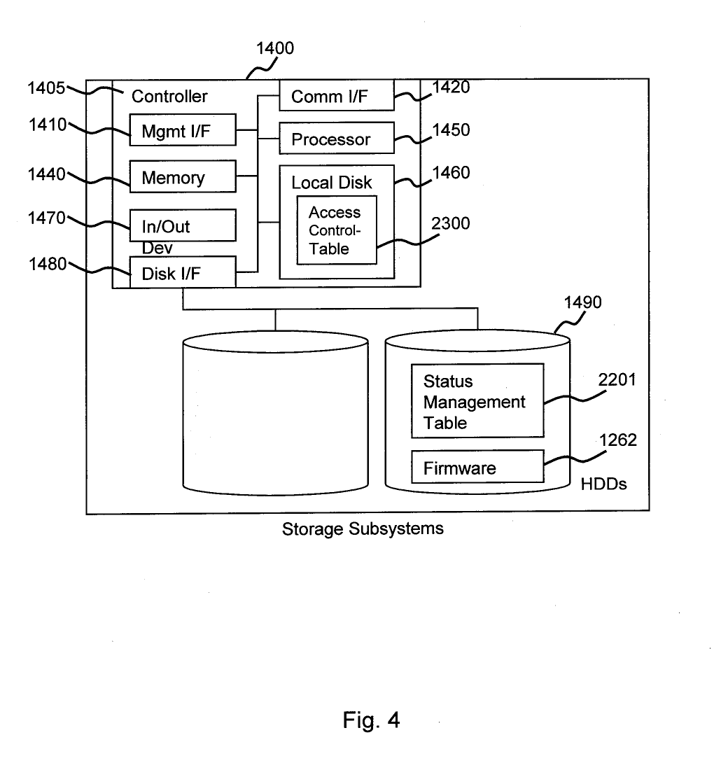

FIG. 4 shows an example of a configuration of the Storage Subsystem 1400 in the Datacenter 1100 according to the first embodiment. The Storage Subsystem 1400 includes Controller 1405 and HDDs 1490. The Controller 1405 includes Management Interface 1410, Communication Interface 1420, Memory 1440, Processor 1450, Local Disk 1460, Input/Output Device 1470, and Disk Interface 1480. The Management Interface 1410 is an interface to the Management Network 1020. The Communication Interface 1420 is an interface to the Data Network 1030. The Disk Interface 1480 is an interface to the HDDs 1490. The Local Disk 1460 contains Access Control Table 2300. The Storage Subsystem 1400 contains several HDDs (Hard Disk Drives), and two are shown in FIG. 4. In different embodiments, SSDs (Solid State Disks) and some other media can be used.

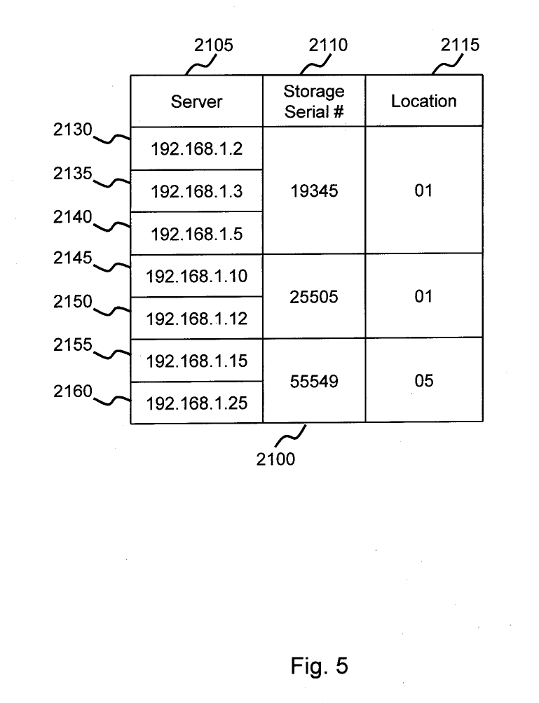

FIG. 5 shows an example of Mapping Management Table 2100 in the Management Server 1200 according to the first embodiment. The Mapping Management Table 2100 is created in the Memory 1240 of the Management Server 1200 by the Firmware Management Program 1264. The Server column 2105 shows the identification of each server 1300 in the Datacenter 1100. The Storage Serial Number column 2110 shows the identification of each storage subsystem 1400 in the Datacenter 1100. The Location column 2115 shows reference (location) of the firmware. Each server 1300 refers to this Location to get the firmware. In this embodiment, the location is represented by the LDEV number. Each row 2130 to 2160 shows mapping between server and storage. Each server 1300 refers to the storage serial number field to get the firmware.

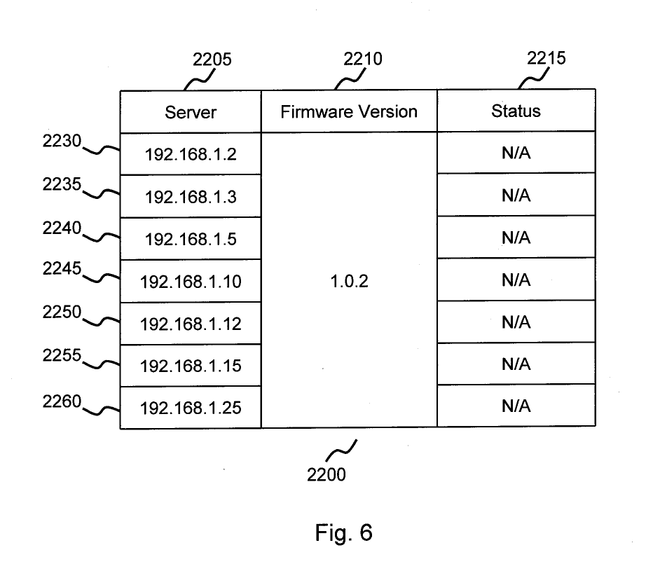

FIG. 6 shows an example of the Status Management Table 2200 in the Management Server 1200 according to the first embodiment. The Status Management Table 2200 is created in the Memory 1240 of the Management Server 1200 by the Firmware Management Program 1264. The Server column 2205 shows the identification of each server 1300 in the Datacenter 1100. The Firmware Version column 2210 shows version number of firmware to apply. The Status column 2215 shows the status of firmware update. Each row 2230 to 2260 shows the status of firmware update of each server.

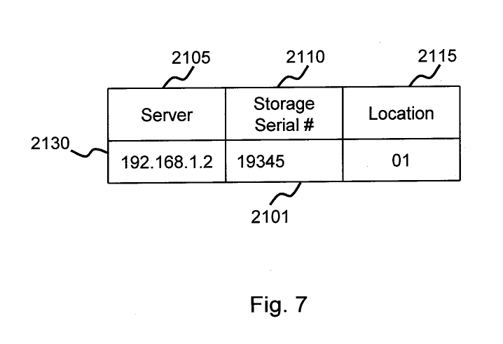

FIG. 7 shows an example of the Mapping Management Table 2101 in the Server 1300. The Mapping Management Table 2101 in the Memory 1340 of the Server 1300 is deployed from the Management Server 1200. The Server column 2105, Storage Serial Number column 2110, and Location column 2115 are the same as those in the Mapping Management Table 2100 (FIG. 5). The row 2130 shows mapping between server and storage.

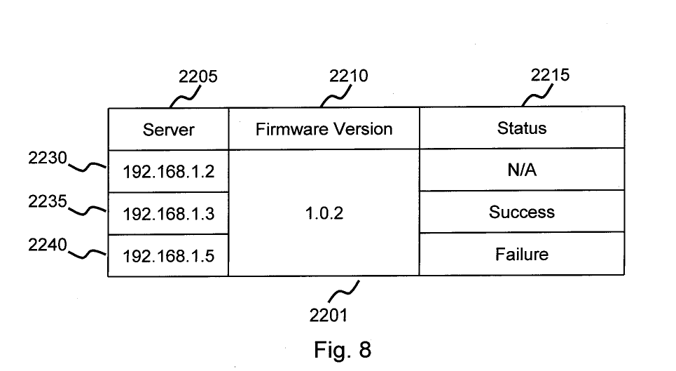

FIG. 8 shows an example of the Status Management Table 2201 in the Storage Subsystem 1400 according to the first embodiment. The Status Management Table 2201 is stored in the HDD 1940, and has the same Server column 2205, Firmware Version column 2210, and Status column 2215 as the Status Management Table 2200 (FIG. 6).

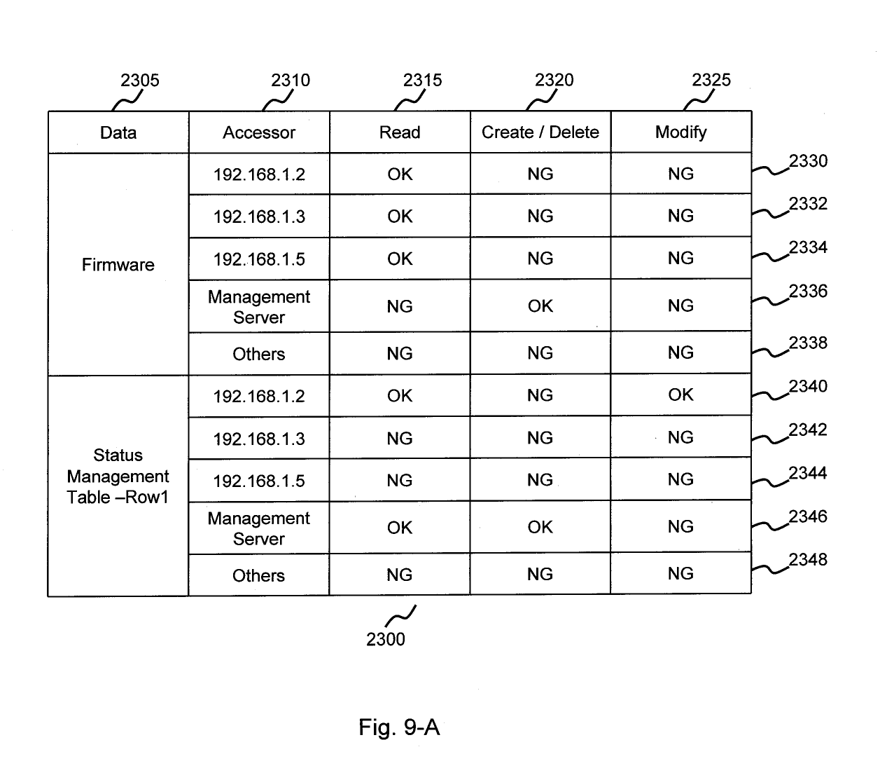

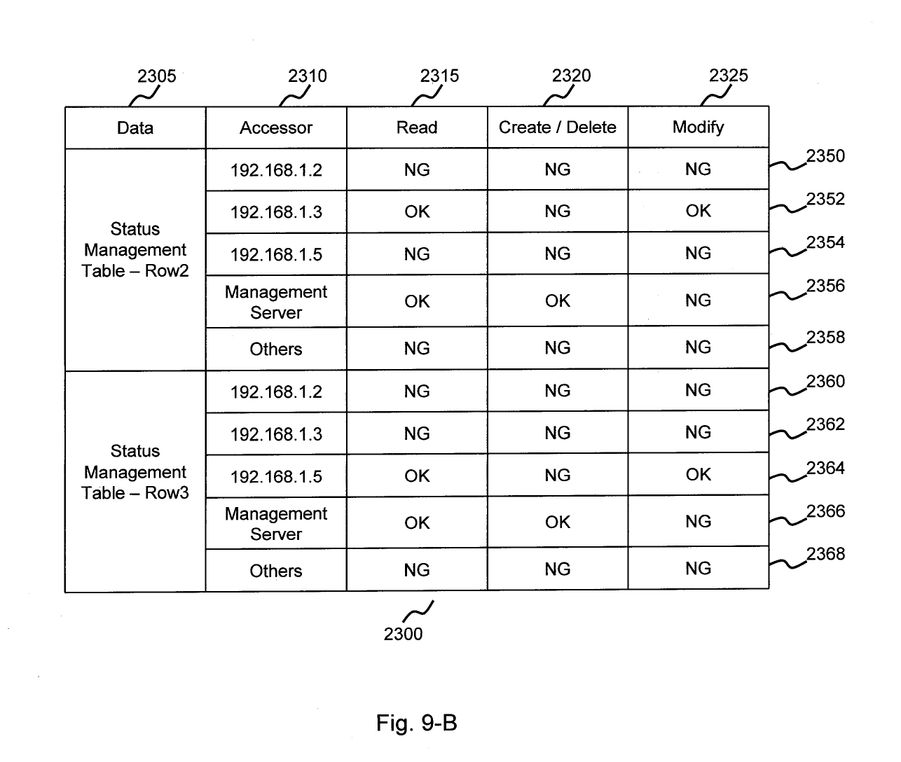

FIG. 9 (parts 9-A and 9-B) shows an example of the Access Control Table 2300 in the Storage Subsystem 1400 according to the first embodiment. The Data row 2305 shows the data which is access controlled according to this table. The Accessor row 2310 shows the accessor to the data. The Read row 2315 shows the read permission (OK or NG). The Create/Delete row 2320 shows create and delete permission (OK or NG). The Modify row 2325 shows the write permission (OK or NG). All I/O requests to the Storage Subsystem 1400 refer this Access Control Table 2300. If the result of the lookup is “OK,” the request is executed. If the result of the lookup is “NG,” the request is denied. For example, a read request from Server 192.168.1.2 to Firmware is accepted, but a read request from Management Server to Firmware is denied by looking up the Access Control Table 2300.

As seen in FIG. 9, each row of the status management table has a different access control. Therefore, each server can only access specified row of the status management table. For example, only server 192.168.1.5 can access the third row of the status management table as shown in rows 2360, 2362, and 2364. Other servers cannot access the third row of the status management table according to the Access Control Table 2300 of FIG. 9.

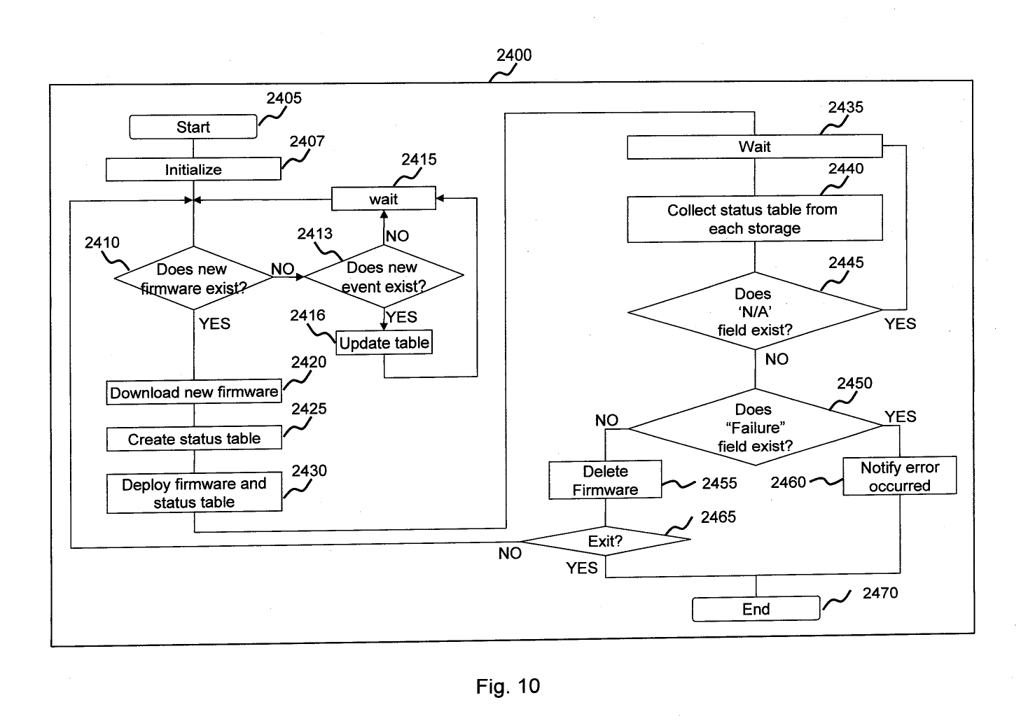

FIG. 10 shows an example of a flow diagram 2400 illustrating the process of the Firmware Update Program 2601 of the Server 1300 as applied to the Management Server 1200. The process starts at step 2405. In step 2407, the program initializes the process to create the Mapping Management Table 2100 and Status Management Table 2200 in the Memory 1240 of the Management Server 1200 and to deploy subset of the Mapping Management Table 2100 to each Server 1300. The Mapping Management Table 2100 is created as follows. The first step is to decide a “Ratio,” which is a number of servers per storage. For example, the Ratio is 100. If the number of servers in the data center is 1000, the number of storages which store firmware is 10. Therefore, the next step is to select 10 storages and then provision LDEV. Each server is assigned to the above storages by using a round-robin approach, for example. Based on this, the Mapping Management Table 2100 is created.

In step 2410, the program confirms with the Vendor's site 1800 to determine whether the latest firmware exists. If the latest firmware exists, the program proceeds to step 2420. If the latest firmware does not exist, the program proceeds to step 2413. In step 2413, the program confirms whether a new event has arrived or not. If yes, the program proceeds to step 2416; it no, the program proceeds to step 2415. In step 2415, the program waits for a while, and then goes to step 2410. In step 2416, the program updates the Mapping Management Table 2100 based on the event. Details of this procedure are shown in FIG. 11; after the procedure is completed, the program goes to step 2415. In step 2420, the program downloads the latest firmware. In step 2425, the program creates the Status Management Table 2200 in the Memory 1240. All of the Status fields 2215 in this table are initialized by “N/A.” In step 2430, the program deploys firmware and subset of the Status Management Table 2200 to each Storage Subsystem 1400 based on the Mapping Management Table 2100. In step 2435, the program waits for a while, and then goes to step 2440. In step 2440, the program collects the Status Management Table 2201 from each Storage Subsystem 1400.

In step 2445, the program checks whether “N/A” field exists in the Status Management Table 2201 of the Storage System 1400. If there is no “N/A” field, then the program goes to step 2450; otherwise, it goes to Step 2435. In step 2450, the program checks whether ‘“Failure” field exists in the Status Management Table 2201 of the Storage System 1400. If there is no “Failure” field, then the program goes to step 2455; otherwise, the program goes to Step 2460. In step 2455, the program deletes firmware and subset of the Status Management Table 2201 of each Storage Subsystem 1400, and then goes to step 2465. In step 2460, the program notifies the error to the user, and then goes to step 2470 and the process ends. In step 2465, the program checks whether the termination indication by the user exists. If termination indication exists, the program proceeds to step 2470 and the process ends; otherwise, the program goes to step 2410.

FIG. 11 shows an example of a flow diagram 2500 illustrating the process of the Firmware Management Program 1264 to update the Mapping Management Table 2100 in the Management Server 1200 in step 2416 of FIG. 10. When the Datacenter environment is changed such as by adding server or adding storage subsystem, the “event” is notified and then the process of this program is executed. The program starts at step 2510. In step 2520, the program checks the event type. If the event type is “Delete Storage Subsystem” from Datacenter, the process goes to step 2530 and then step 2570. If the event type is “Add Server” to Datacenter, the process goes to step 2540 and then step 2570. If the event type is “Delete Server” from Datacenter, the process goes to step 2550 and then step 2570. If the event type is “Add Storage Subsystem” to Datacenter, the process goes to step 2560.

In step 2530, the program modifies the Mapping Management Table 2100 in the Management Server 1200. If the deleted storage subsystem does not exist in the Storage Subsystem field 2110 of the Mapping Management Table 2100, the program does nothing. If the deleted storage subsystem exists in the Storage Subsystem field 2110 of the Mapping Management Table 2100, the program modifies the Mapping Management Table 2100. The program further decides the alternate Storage Subsystem in place of the deleted Storage Subsystem. The alternate Storage Subsystem may be a similar type of storage to relevant Server or may be decided by round robin.

In step 2540, the program adds the row of the specified Server to the Mapping Management Table 2100 in the Management Serer 1200. The program checks the number of assigned servers of each storage in the Mapping Management Table 2100. In the case where the assigned number is less than the Ratio for a storage, the program selects the least assigned storage and assign the server to that storage; otherwise, the programs selects a new storage and assigns the server to the new storage. In step 2550, the program deletes the row of the specified Server from the Mapping Management Table 2100 in Management Server 1200. In step 2560, the program does nothing, and then goes to step 2580 and the process ends. In step 2570, the program updates the Mapping Management Table 2100 based on step 2530, 2540, or 2550, and then goes to step 2580 and the process ends.

FIG. 12 shows an example of a flow diagram 2600 illustrating the process of the Firmware Update Program 2601 in the Server 1300. The program starts at step 2605. In step 2610, the program checks whether new firmware exist in the Storage Subsystem 1400. Which storage Subsystem to check is decided based on Mapping Management Table 2101. If new firmware exists, the process goes to step 2620. If new firmware does not exist, the process goes to step 2615. In step 2615, the program waits for a while, and then goes to step 2610. In step 2620, the program downloads new firmware. In downloading new firmware, the target volume is mounted in read only mode. By doing this, multiple mount by plural servers is allowed. In step 2625, the program applies the new firmware to the Server 1300. In step 2630, the program checks whether the firmware installation succeeds. If the firmware installation succeeds, the process goes to step 2635. If the firmware installation fails, the process goes to step 2640.

In step 2635, the program writes “Success” to the Status field 2215 in Status Management Table 2201 in the Storage Subsystem 1400. To write “Success” to the Status field, the target volume is mounted in modify mode. By checking the Access Control Table 2300, the program ensures that plural servers cannot access the same row of the Status Management Table. Therefore, multiple write is allowed. For example, if the storage has a row level locking mechanism, this mechanism can be used.

In step 2640, the program writes “Failure” to the Status field 2215 in the Status Management Table 2201 in the Storage Subsystem 1400. To write “Failure” to the Status field, the target volume is mounted in modify mode. The program ends at step 2645. By checking the Access Control Table 2300, the program ensures that plural servers cannot access the same row of the Status Management Table. Therefore, multiple write is allowed. For example, if the storage has a row level locking mechanism, this mechanism can be used.

### Embodiment 2

### Updating Firmware of Storage Subsystem

The system configuration of embodiment 2 is almost the same as that of embodiment 1. The following describes only features of embodiment 2 that are different from those of embodiment 1.

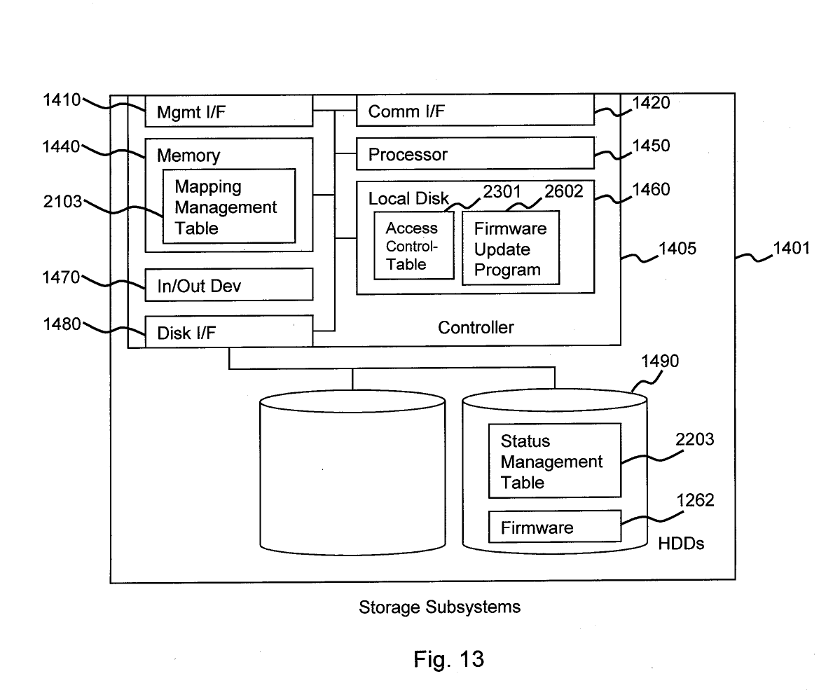

FIG. 13 shows an example of a configuration of the Storage Subsystem 1400 in the Datacenter 1100 according to the second embodiment. Mapping Management Table 2103 exists in Memory 1440. Firmware Update Table 2602 exists in the Local Disk 1450 of the Controller 1405.

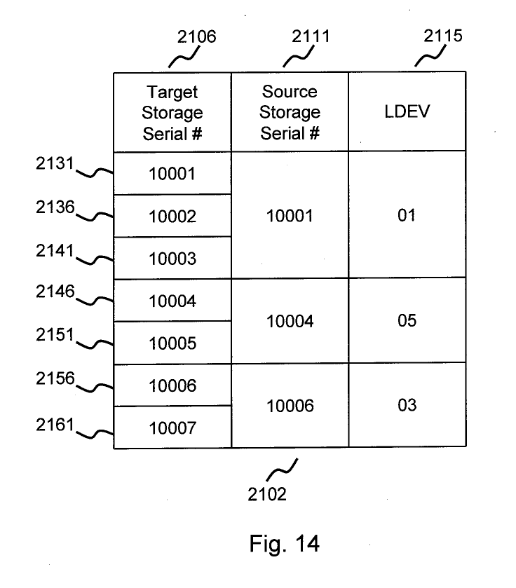

FIG. 14 shows an example of Mapping Management Table 2102 in the Management Server 1200 according to the second embodiment. The Mapping Management Table 2102 is created in the Memory 1240 of the Management Server 1200 by the Firmware Management Program 1264. The Target Storage Subsystem column 2106 shows the identification of each Storage Subsystem 1400 in the Datacenter 1100. The Source Storage Subsystem column 2111 shows the identification of each Storage Subsystem 1400 in the Datacenter 1100. The Location column 2115 shows reference of the firmware. Each Storage Subsystem 1400 refers to this Location column 2115 to get the firmware. Each row 2131 to 2161 shows mapping between target storage subsystem and source storage subsystem. Each target storage subsystem refers to the Source Storage Subsystem field 2111 to get the firmware.

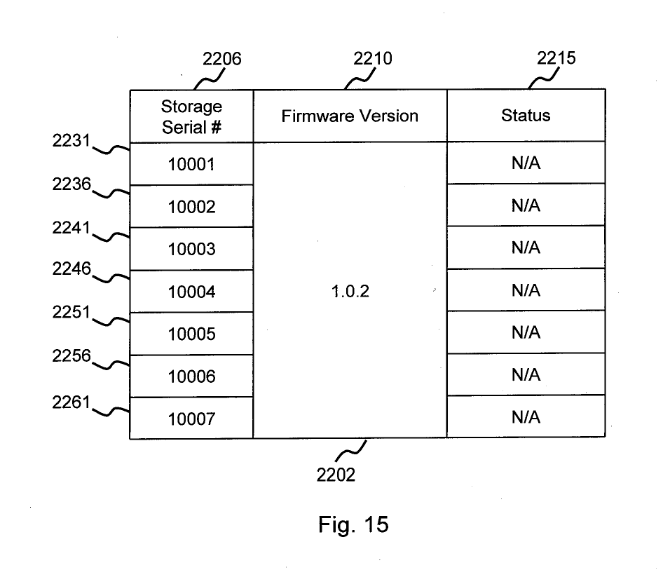

FIG. 15 shows an example of Status Management Table 2202 in the Management Server 1200 according to the second embodiment. The Storage Serial Number column 2206 shows the identification of each Storage Subsystem 1400 in the Datacenter 1100. Each row 2231 to 2261 shows the status of firmware update of each Storage Subsystem 1400.

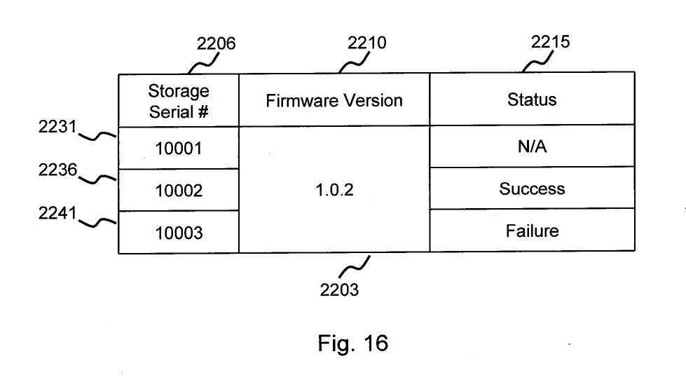

FIG. 16 shows an example of Status Management Table 2203 in the Storage Subsystem 1400 according to the second embodiment. The Status Management Table 2203 is stored in the Storage Subsystem HDD 1940. It has the same columns as those of the Status Management Table 2202 in the Management Server 1200 as seen in FIG. 15.

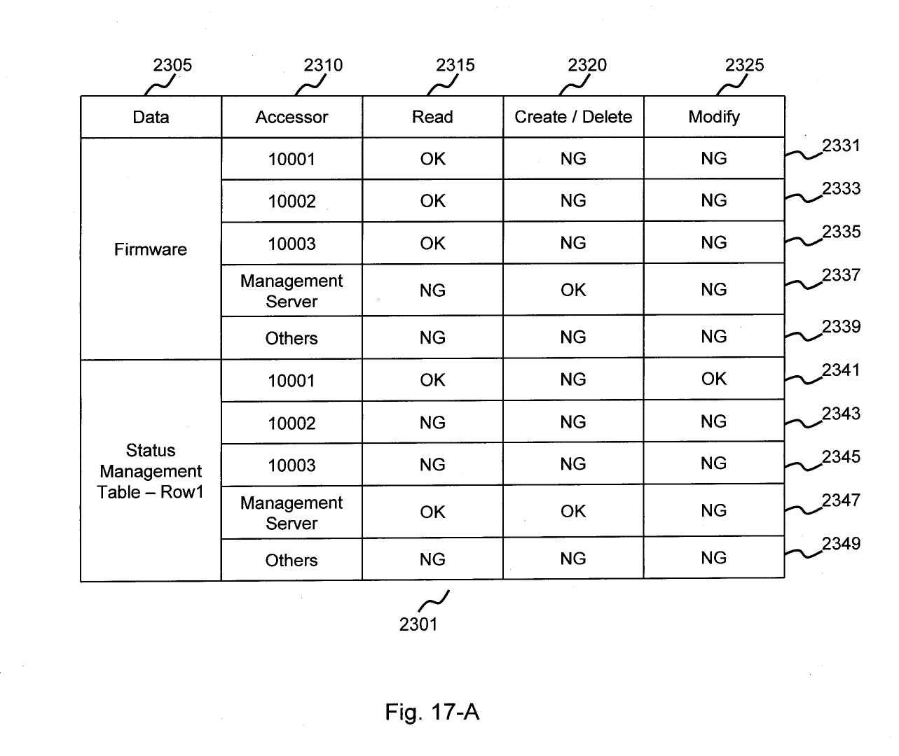

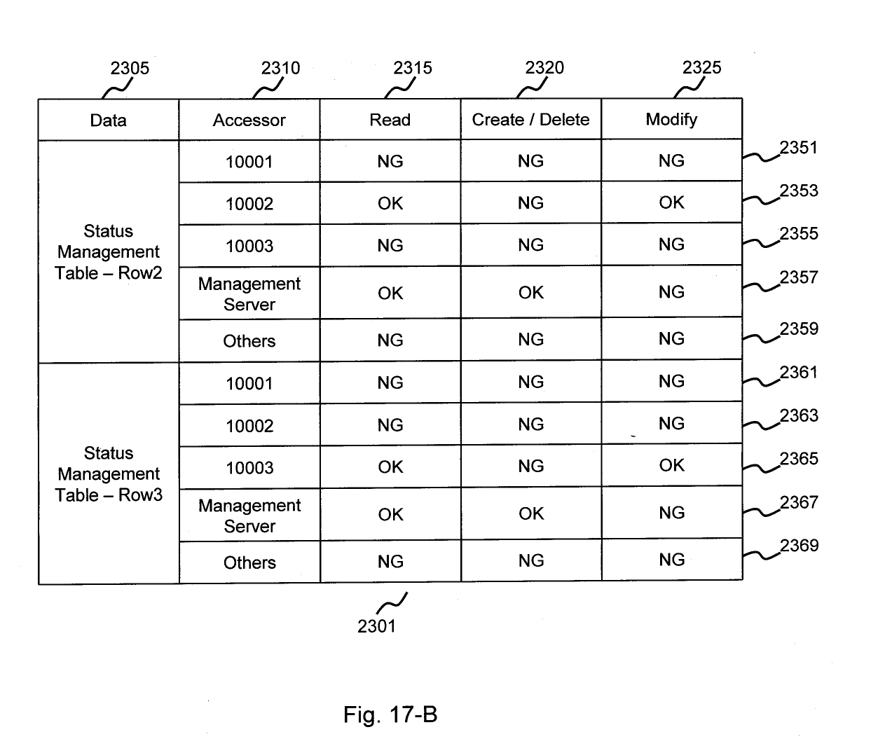

FIG. 17 (parts 17-A and 17-B) shows an example of Access Control Table 2301 in the Storage Subsystem 1400 according to the second embodiment. This table is similar to the Access Control Table 2300 of FIG. 9. For example, a read request from Storage to Firmware is accepted, but a read request from Management Server to Firmware is denied by looking up the Access Control Table 2301. Each row of the status management table has a different access control. Therefore, each storage can only access specified row of the status management table. For example, only storage 10001 can access the first row of the status management table as shown in rows 2341, 2343, and 2345 of the Access Control Table 2301 of FIG. 17. Other storages cannot access the first row of the status management table.

### Embodiment 3

### Applying Patch to Virtual Machine

The system configuration of embodiment 3 is almost the same as that of embodiment 1. The following describes only features of embodiment 3 that are different from those of embodiment 1.

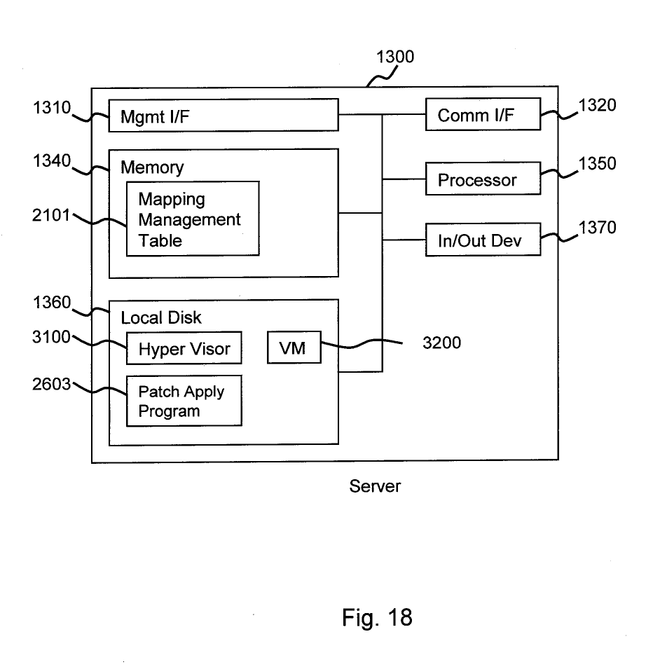

FIG. 18 shows an example of a configuration of the Server 1300 according to the third embodiment. The Local Disk 1360 contains Hyper Visor 3100 and Virtual Machine (VM) 3200. The Local Disk 1360 may contain more than one Hyper Visor 3100 and more than one Virtual Machine 3200 in other embodiments. The Hyper Visor 3100 is loaded to the Memory 1340 and executed by the Processor 1350. More than one Virtual Machine 3200 are loaded to the Memory 1340 and executed on the Hyper Visor 3100 by the Processor 1350.

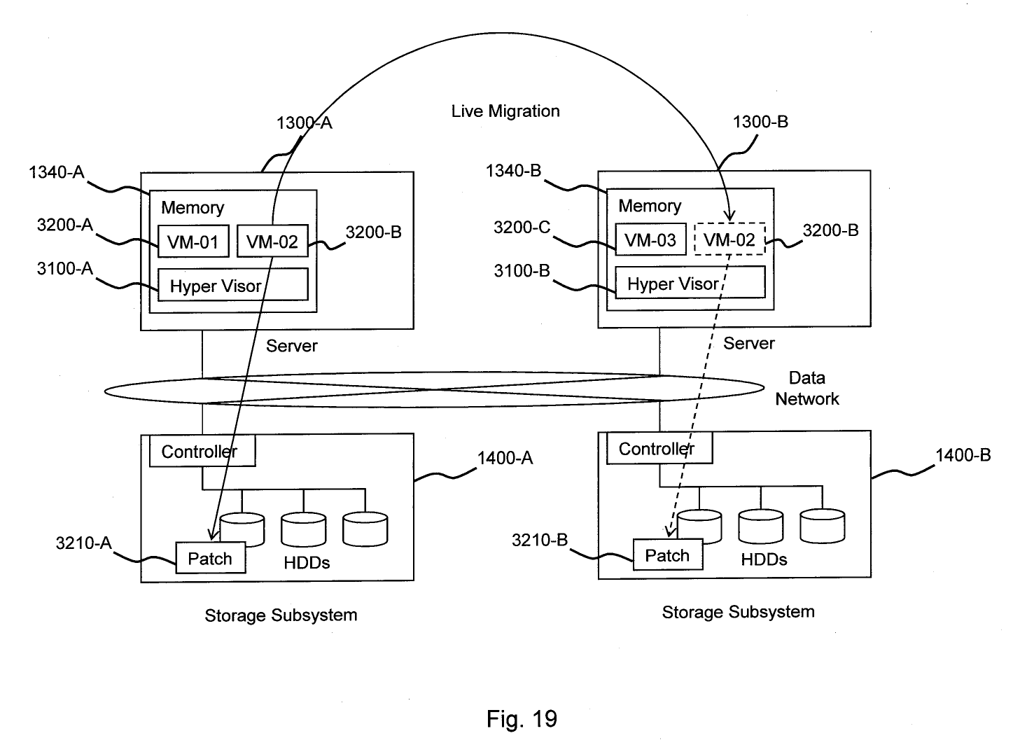

FIG. 19 shows an example of a logical configuration of a Datacenter system that includes Servers 1300-A, 1300-B and Storage Subsystems 1400-A, 1400B according to the third embodiment. Hyper Visor 3100-A is executed on Memory 1340-A of Server 1300-A. VM-01 3200-A and VM-02 3200-B are executed on the Hyper Visor 3100-A. Hyper Visor 3100-B are executed on Memory 1340-B of Server 1300-B. VM-03 3200-C is executed on the Hyper Visor 3100-B.

In embodiment 1, each Server 1300 can download the firmware by referring to the Mapping Management Table 2101 (see FIG. 18). In a similar way, the virtual machine can download the patch in embodiment 3. The Hyper Visor 3100 has the Mapping Management Table 2101 in the Memory 1340. In the Mapping Management Table 2101, the location of the patch on the Storage Subsystem 1400 is described. The Virtual Machine 3200 inquires the location of Patch 3210 of the Virtual Machine. If the latest patch exists, the Virtual Machine downloads the latest patch and installs it.

The Virtual Machine may migrate among the Hyper Visors. Migration technology such as Live Migration is known. For example, VM-02 is migrated from Hyper Visor 3100-A on Server 1300-A to Hyper Visor 3100-B on Server 1300-B by using the Live Migration function. In that case, VM-02 can access Patch 3210-B by inquiring the location of the Patch of the Hyper Visor 3100-B. In this way, the Virtual Machine can download the latest patch from a near or local storage subsystem even if the Virtual Machine is moved by live migration.

### Embodiment 4

### Applying Patch to Virtual Machine in Converged Platform Environment

Converged Platform is one hardware configuration which includes server, network, and storage all-in-one. The following describes only features of embodiment 4 that are different from those of embodiment 3.

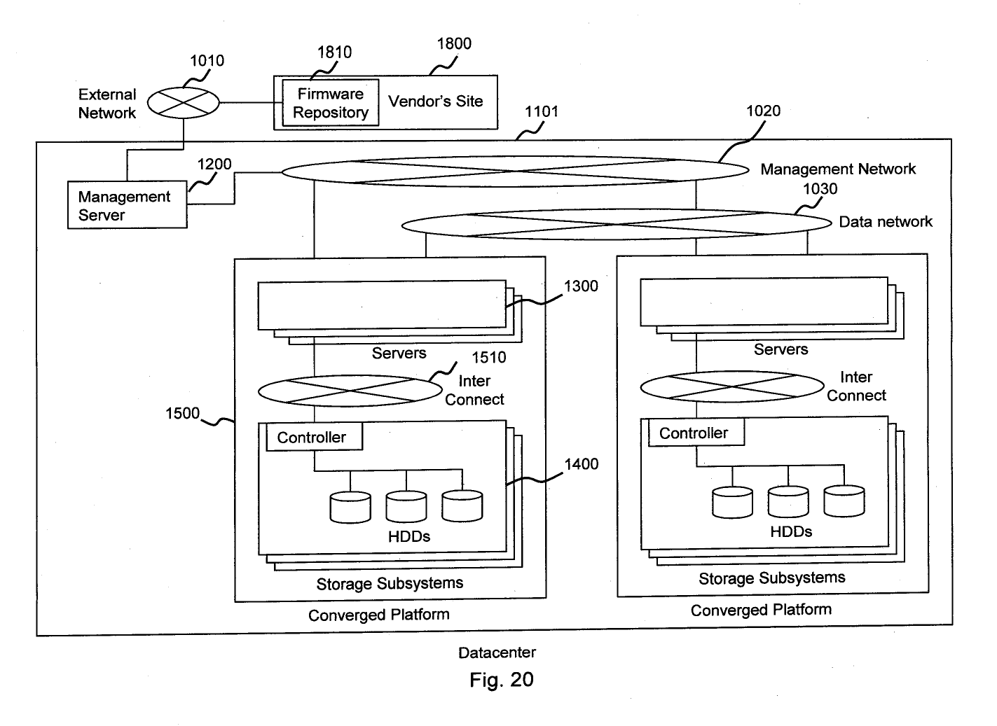

FIG. 20 shows an example of a system configuration of the Datacenter system according to the fourth embodiment. The following describes only features that are different from those of FIG. 1. The Datacenter 1101 includes Converged Platforms 1500 and Management Server 1200. The Converged Platform 1500 includes Servers 1300, Storage Subsystems 1400, and Inter Connect 1510. Multiple Converged Platforms 1500 are connected via Data Network 1030. The Converged Platforms 1500 and Management Server 1200 are connected via Management Network 1020.

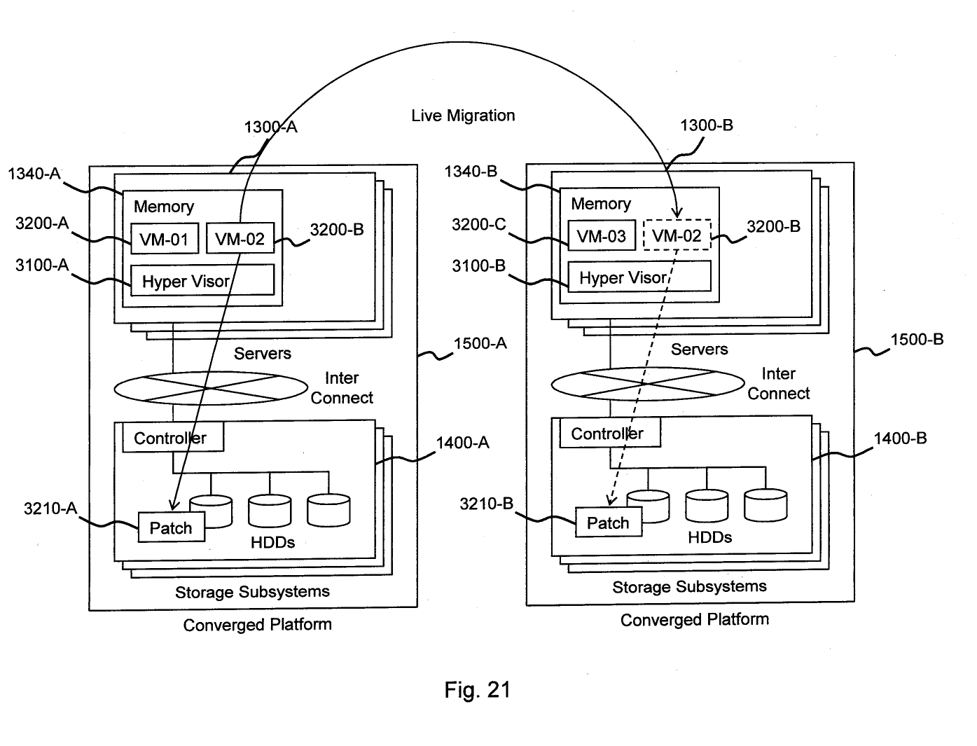

FIG. 21 shows an example of a logical configuration of the system that includes the Converged Platforms 1500 according to the fourth embodiment. In this embodiment, the Mapping Management Table can be created in a different way from embodiment 1. For example, the program selects one storage subsystem from one converged platform. All the servers in the converged platform refer to the selected storage subsystem. By doing this, all the servers can download a patch from “Local Disk.” As a result, reference of the Patch can be automatically switched when the live migration among the Converged Platforms 1500 occurs. For example, VM-01 3200-A and VM-02 3200-B on Hyper Visor 3100-A refer to Patch 3210-A on Storage Subsystem 1400-A in Converged Platform 1500-A. When VM-02 is migrated to Server 1300-B, reference of “Local Disk” is changed to Storage Subsystem 1400-B. Therefore, VM-02 3200-B on Hyper Visor 3100-B refers to Patch 3210-B on Storage Subsystem 1400-B in Converged Platform 1500-B. In this way, the Virtual Machine can download the latest patch from local storage subsystem even if the Virtual Machine is moved by live migration.

Of course, the system configurations illustrated in FIGS. 1 and 20 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for deploying firmware/patch. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. An information system comprising:
a plurality of storage systems;
a plurality of servers;
a management server; and
a network coupled with the storage systems, the servers, and the management server;
wherein the management server is configured to specify one or more storage areas in one or more of the storage systems for distributing a firmware, and to create an access control table which sets access control for permissible access to the firmware in the one or more storage areas in one or more of the storage systems;
wherein the servers are configured to download the firmware from the one or more storage areas by checking the access control table for permission to download the firmware, to apply the downloaded firmware if the firmware is downloaded, and to write, to the one or more storage areas from which the firmware has been downloaded, status information indicating result of applying the downloaded firmware; and
wherein the management server is configured to acquire the status information from each of the one or more storage areas from which the firmware has been downloaded.

2. The information system according to claim 1,
wherein the one or more servers are configured, prior to writing status information indicating result of applying the downloaded firmware, to check the access control table which sets access control for permissible updating of the status information in each of the one or more storage areas from which the firmware has been downloaded to indicate success or failure of applying the downloaded firmware by the one or more servers.

3. The information system according to claim 1,
wherein the management server is configured to check the status information in each of the one or more storage areas from which the firmware has been downloaded, and to delete the firmware in a specific storage area if the status information indicates success of applying the firmware downloaded from the specific storage area.

4. The information system according to claim 1,
wherein the management server is configured to check the status information in each of the one or more storage areas from which the firmware has been downloaded, and to notify an error if the status information indicates failure of applying the firmware downloaded from a specific storage area.

5. The information system according to claim 1,
wherein the management server is configured to create a mapping management table which maps each server to any storage area in the storage systems from which the server may download a firmware; and
wherein the servers are configured to check whether any new firmware exists in the storage systems by using the mapping management table.

6. The information system according to claim 1,
wherein the management server is configured to create a mapping management table which maps one or more target storage systems from among the plurality of storage systems to one or more storage areas in one or more source storage systems from among the plurality of storage systems, a target storage system being permitted to download a firmware from a storage area in a source storage system as mapped according to the mapping management table; and
wherein the one or more target storage systems are configured to download the firmware from the one or more storage areas of the one or more source storage systems by checking the access control table for permission to download the firmware, and to apply the downloaded firmware if the firmware is downloaded, and to write, to the one or more storage areas from which the firmware has been downloaded, status information indicating result of applying the downloaded firmware.

7. The information system according to claim 1,
wherein one or more of the servers each include one or more virtual machines;
wherein the firmware comprises a patch; and
wherein the one or more virtual machines are configured to download the patch from the one or more storage areas by checking the access control table for permission to download the patch, to apply the downloaded patch if the patch is downloaded, and to write, to the one or more storage areas from which the patch has been downloaded, status information indicating result of applying the patch.

8. The information system according to claim 7,
wherein the servers and storage systems are divided into a plurality of converged platforms which are coupled via the network, each converged platform having a subset of the servers and a subset of the storage systems;
wherein for each converged platform, the management server specifies a storage area in one storage system in the subset of the storage systems for distributing a patch in the converged platform, and the access control table sets access control for permissible access to the patch in the storage area by the virtual machines of all the servers in the same converged platform.

9. An information system comprising:
a plurality of storage systems;
a plurality of servers;
a management server; and
a network coupled with the storage systems, the servers, and the management server;
wherein the management server is configured to specify one or more storage areas in one or more of the storage systems for distributing a firmware, and to create an access control table which sets access control for permissible access to the firmware in the one or more storage areas in one or more of the storage systems;
wherein the management server is configured to create a mapping management table which maps one or more target storage systems from among the plurality of storage systems to one or more storage areas in one or more source storage systems from among the plurality of storage systems, a target storage system being permitted to download a firmware from a storage area in a source storage system as mapped according to the mapping management table;
wherein the one or more target storage systems are configured to download the firmware from the one or more storage areas of the one or more source storage systems by checking the access control table for permission to download the firmware, and to apply the downloaded firmware if the firmware is downloaded, and to write, to the one or more storage areas from which the firmware has been downloaded, status information indicating result of applying the downloaded firmware; and
wherein the management server is configured to acquire the status information from each of the one or more storage areas from which the firmware has been downloaded.

10. The information system according to claim 9,
wherein the one or more target storage systems are configured, prior to writing status information indicating result of applying the downloaded firmware, to check the access control table which sets access control for permissible updating of the status information in each of the one or more storage areas from which the firmware has been downloaded to indicate success or failure of applying the downloaded firmware by the one or more target storage systems.

11. The information system according to claim 9,
wherein the management server is configured to check the status information in each of the one or more storage areas from which the firmware has been downloaded, and to delete the firmware in a specific storage area if the status information indicates success of applying the firmware downloaded from the specific storage area.

12. The information system according to claim 9,
wherein the management server is configured to check the status information in each of the one or more storage areas from which the firmware has been downloaded, and to notify an error if the status information indicates failure of applying the firmware downloaded from a specific storage area.

13. An information system comprising:
a plurality of storage systems;
a plurality of servers each including one or more virtual machines;
a management server; and
a network coupled with the storage systems, the servers, and the management server;
wherein the management server is configured to specify one or more storage areas in one or more of the storage systems for distributing a patch, and to create an access control table which sets access control for permissible access to the patch in the one or more storage areas in one or more of the storage systems;
wherein the one or more virtual machines are configured to download the patch from the one or more storage areas by checking the access control table for permission to download the patch, to apply the downloaded patch if the patch is downloaded, and to write, to the one or more storage areas from which the patch has been downloaded, status information indicating result of applying the patch; and
wherein the management server is configured to acquire the status information from each of the one or more storage areas from which the patch has been downloaded.

14. The information system according to claim 13,
wherein the one or more virtual machines are configured, prior to writing status information indicating result of applying the patch, to check the access control table which sets access control for permissible updating of the status information in each of the one or more storage areas from which the patch has been downloaded to indicate success or failure of applying the patch by the one or more virtual machines.

15. The information system according to claim 13,
wherein the management server is configured to check the status information in each of the one or more storage areas from which the patch has been downloaded, and to delete the patch in a specific storage area if the status information indicates success of applying the patch downloaded from the specific storage area.

16. The information system according to claim 13,
wherein the management server is configured to check the status information in each of the one or more storage areas from which the patch has been downloaded, and to notify an error if the status information indicates failure of applying the patch downloaded from a specific storage area.

17. The information system according to claim 13,
wherein the management server is configured to create a mapping management table which maps each virtual machine to any storage area in the storage systems from which the virtual machine may download a patch; and
wherein the virtual machines are configured to check whether any new patch exists in the storage systems by using the mapping management table.

18. The information system according to claim 13,
wherein the management server is configured to create a mapping management table which maps one or more target storage systems from among the plurality of storage systems to one or more storage areas in one or more source storage systems from among the plurality of storage systems, a target storage system being permitted to download a patch from a storage area in a source storage system as mapped according to the mapping management table; and
wherein the one or more target storage systems are configured to download the patch from the one or more storage areas of the one or more source storage systems by checking the access control table for permission to download the patch, and to apply the downloaded patch if the patch is downloaded, and to write, to the one or more storage areas from which the patch has been downloaded, status information indicating result of applying the downloaded patch.

19. The information system according to claim 13,
wherein the servers and storage systems are divided into a plurality of converged platforms which are coupled via the network, each converged platform having a subset of the servers and a subset of the storage systems;
wherein for each converged platform, the management server specifies a storage area in one storage system in the subset of the storage systems for distributing a patch in the converged platform, and the access control table sets access control for permissible access to the patch in the storage area by the virtual machines of all the servers in the same converged platform.
